(19) United States
(12) Patent Application Publication
(10) Pub. No.: US 2004/0022390 A1
(43) Pub. Date: Feb. 5, 2004

(54) System and method for data protection and secure sharing of information over a computer network

(76) Inventors: Jeremy D. McDonald, La Jolla, CA (US); Richard A. Fastring, El Cajon, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/212,018

(22) Filed: Aug. 2, 2002

(51) Int. Cl. H04L 9/00

(52) U.S. Cl. 380/277; 713/150

(57) ABSTRACT

A system and method for data protection and secure sharing of information over a computer network. Data objects are subjected to a first level of encryption at their creation based on their content and the credentials or security attributes of the originating user. The first level of encryption has both symmetric and asymmetric aspects. A second level of encryption is employed to establish a secure network for transit of the object over the network to a recipient user or to a common server. The recipient user is granted access to the object only if he possesses the appropriate credentials and security attributes. A configurable policy system implements and manages these principles of access control as a rule based system, and manages and distributes the keys and material necessary to implement the cryptographic functions. A further level of protection is provided by strong identification, authentication and authorization implemented at user workstations by a means independent of a workstation's untrusted operating system.

### FIELD OF THE INVENTION

The present invention relates to a system and method for data protection and, more particularly, relates to a rule-based access control system and method in which data is encrypted both at its origin based on its content and user credentials and again as it transits a computer network.

### BACKGROUND OF THE INVENTION

Organizations such as government agencies, commands, services and multi-national coalitions face difficult challenges in the secure exchange and protection of information over computer networks. There is no “single” network with a common security paradigm. Rather, each organization tends to have its own network. Elaborate and unique security solutions are required when organizations wish to share information residing on their separate computer networks in a secure and access-controlled manner. This is a very resource intensive activity and often ineffective in achieving the desired level of security. Often, organizations ultimately find that the “sneaker net” is their only option for sharing information with other organizations in a reliably secure and confidential manner. That is, the information must be printed or stored on computer media and physically delivered by a trusted party to its intended recipient.

Even where there is a secure network in place between organizations wishing to exchange information, there is no means for restricting access to that information to a desired cross-section of recipients. Interoperability requires a new and secure networking paradigm.

### SUMMARY OF THE INVENTION

The present invention provides a system and method for data protection in which secure sharing of information is not restricted by separate physical networks. A single network infrastructure solution reduces manpower and complexity, and provides the flexibility to permit secure information exchange between remote entities, organizations and governments.

In accordance with one embodiment of the present invention, a system for protection and secure exchange of data objects over a computer network is provided. An object access control subsystem implements a first cryptographic function based on the content of the objects and the credentials of an originating user. Access to objects is granted only to recipient users possessing appropriate credentials. A network access control subsystem implements a second cryptographic function based on attributes of the network to ensure secure and confidential transit of the data objects over the network.

Another embodiment of the invention provides a method for secure exchange of data objects over a computer network. The method includes the steps of identification, authentication and authorization of an originating user, and determination of the originating user's credentials. Object and network cryptographic keys and materials are assigned to the originating user based on the originating user's credentials. A first level of encryption is performed on a data object using the object keys and materials assigned to the originating user, and a second level of encryption is performed on the data object using the network keys and materials assigned to the originating user. The data object is then sent over the computer network to a recipient user. If the recipient user has appropriate network keys, a first level of decryption is performed on the data object, and if the recipient user has appropriate object keys and materials, a second level of decryption is performed on the data object. The decrypted object may then be accessed by the recipient user.

A further embodiment of the invention provides a method for encrypting/decrypting a data object. A symmetric key is generated from a plurality of key elements, one of which is a first key element that is not in possession of an intended recipient. In one implementation, the key elements include a prime modulus “p”, a primitive element “g” that is a member of a one-way hashed series and a random number “R”. In this implementation, the random number “R” is not in the possession of the intended recipient. The data object is encrypted using the symmetric key, and the first key element is encrypted using an asymmetric key. In one implementation, the encrypted first key element (R) is placed in a plaintext header attached to the encrypted data object. The encrypted data object and encrypted first key element are sent to the intended recipient, who must have the decrypting half of the asymmetric key pair in order to generate R and, in turn, generate the symmetric key to decrypt the object.

Other features, objects and implementations of the invention will be or will become apparent to one with skill in the art upon examination of the following figures and detailed description. All such additional features, objects and implementations are intended to be included within this description, to be within the scope of the invention and to be protected by the accompanying claims.

### BRIEF DESCRIPTION OF THE DRAWINGS

FIG. 1 is a system level block diagram of a data protection system, referred to as UIA, according to the present invention.

FIG. 2 is a flow diagram illustrating a method for encrypting data-at-rest, according to the present invention.

FIG. 3 is a flow diagram illustrating operation of the data protection system of FIG. 1.

FIG. 4 is a system level block diagram of one implementation of the UIA data protection system of FIG. 1, according to the present invention.

FIG. 5 is a block diagram illustrating the subsystem components and layout of the system of FIG. 4.

FIG. 6 is a block diagram of a policy data structure according to the present invention.

FIG. 7 is a block diagram showing operation of a policy subsystem according to the present invention.

FIG. 8 is a table relating keys and key materials to subsystem components according to the present invention.

FIG. 9 is a block diagram showing operation of network access control subsystem according to the present invention.

FIG. 10 is a flow diagram illustrating a method for object encryption and decryption according to the present invention.

FIG. 11 is a flow diagram illustrating a method for identification, authentication and authorization according to the present invention.

### DETAILED DESCRIPTION OF THE INVENTION

As is common in security-related fields, many acronyms and abbreviations are used in the description of this invention. To facilitate ease in reading and understanding this specification, a list of the acronyms and abbreviations used is set forth below. Use of these acronyms and the assignment of names and titles to the systems, subsystems and process described herein is not intended as a limitation, but rather, is simply intended to convey an understanding of the invention and to provide concrete examples of the inventive concepts set forth.

Acronyms and Abbreviations

The following acronyms and abbreviations are used in this specification:

| | |
|---|---|
| ANSI | American National Standards Institute |
| CKEK | Community Key Encrypting Key |
| CS | Client Subsystem |
| CT | CBIS Token |
| DAR | Data-at-Rest |
| DIT | Data-in-Transit |
| EKMS | Electronic Key Management System |
| g | Primitive Element |
| HAIPE | High Assurance Internet Protocol Encryptor |
| HAIPIS | High Assurance Internet Protocol Interoperability Specifica- |
| | tion |
| HIKE | HAIPE-variant IKE |
| IAA | Identification, Authentication and Authorization |
| IAAS | Identification, Authentication and Authorization Subsystem |
| IKE | Internet Key Exchange |
| INFOSEC | Information Security |
| IP | Internet Protocol |
| ISS | Infrastructure Support Subsystem |
| ISSO | Information Systems Security Officer |
| KEK | Key Encrypting Key |
| KMI | Key Management Infrastructure |
| KMP | Key Management Plan |
| KPS | Key Processing Subsystem |
| Mod | Modulus |
| NAC | Network Access Control |
| NACS | Network Access Control Subsystem |
| NSS | Network Storage Subsystem |
| NTS | Network Translation Subsystem |
| OAC | Object Access Control |
| OACS | Object Access Control Subsystem |
| OEK | Object Encryption Key |
| p | Prime Modulus |
| PS | Policy Subsystem |
| TCS | Trusted Client Subsystem |
| TEK | Traffic Encryption Key |
| TGM | TEK Generation Material |
| TGM_PPK | Pre-Placed TEK Generation Material |
| UIA | Unified Information Assurance |
| UDS | User Data Subsystem |

Unified Information Assurance-“UIA”

The present invention provides a novel data protection system and method that segments information at the network resource level and compartmentalizes the resource further by data content to facilitate secure sharing of information over computer networks. The inventors have coined the term “Unified Information Assurance”(“UIA”) to describe this novel system and method. For sake of convenience and brevity, UIA is also used herein to describe the overall system and method. Use of this term in no way limits or is intended to limit the scope of the invention.

The UIA system functions as a collection of discrete components that work in conjunction to produce access control to network and data resources. The principles of access control are managed as a rule based system set forth in a configurable policy. The policy, in turn, is enforced with a programmable cryptographic solution. A “defense in depth” approach is employed by encrypting information at its origin (“data-at-rest” or “DAR”) based on its content and user authorizations, and also encrypting information as it transits the network (“data-in-transit” or “DIT”). Recipients of the information must possess matching authorizations in order to decrypt the data.

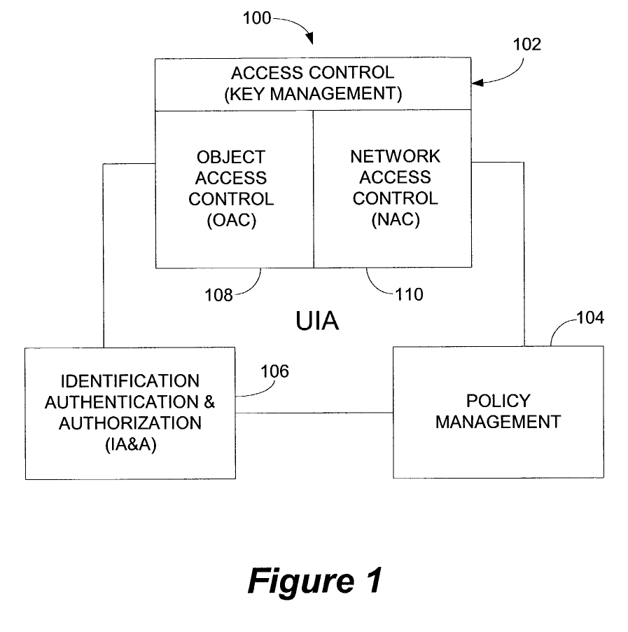

The basic UIA system architecture is illustrated in FIG. 1. UIA system 100 includes an access control component 102, a policy management component 104 and an Identification, Authentication and Authorization (“IAA”) component 106.

At the heart of UIA system 100 are two basic entities: object attributes and network attributes. Each attribute has a one-to-one mapping with a specific cryptographic key. In use, object attribute keys are used to encrypt persistent data (DAR), and network attribute keys are used to establish secure pipelines for transmission of data (DIT). Functionally, network attributes are assigned to and protect network resources. Object attributes are based on the content of the information being protected and hence further segment network resources by content. The use of attributes permits enforcement of access control on individual data elements and protection of the data element throughout the system. As data is transmitted it is protected by DIT encryption (as well as DAR encryption), and in storage it retains DAR encryption, thereby securing the data through the complete life cycle of the information.

Access control component 102 implements this cryptographic separation of networks and data objects and facilitates information sharing between multi-lateral and multi-national markets. Access control component 102 is accordingly broken into two distinct support areas: object access control (“OAC”) 108 and network access control (“NAC”) 110. OAC 108 implements the cryptographic function that protects data-at-rest based on the content of the information.

Data-at-rest (“DAR”) is protected at creation and the cryptographically bound data protection remains on the object until the data is accessed by a user holding the appropriate credentials. In one embodiment of the present invention, a novel combination of symmetric and asymmetric cryptography is used for DAR encryption/decryption. Essentially, a symmetrically encrypted object is protected by an asymmetric key.

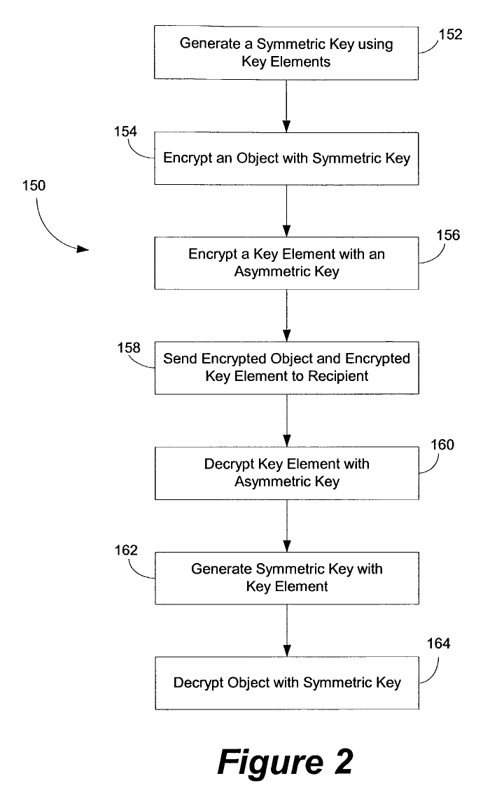

The basic steps of this novel object or DAR encryption method 150 are depicted in FIG. 2. A symmetric object encryption key (“OEK”) is generated by a sender using a plurality of key elements (step 152), and the generated OEK is then used to encrypt an object (step 154). As will be described in more detail below, in one implementation the key elements are “p”, a prime modulus; “g”, a primitive element mod p in a one-way hashed series; and “R”, a random number generated by OAC 108; where OEK(J)=g^{R} mod p. The intended recipient does not have one (or more) of the key elements that was used to generate the OEK. In one implementation, the recipient is missing the random number R. This key element (in one implementation, the random number R) is encrypted using the encrypting half of an asymmetric key pair (step 156).

Both the symmetrically encrypted object and asymmetrically encrypted key element are then sent to a recipient (step 158). The recipient, who possesses the other decrypting half of the asymmetric key pair, uses that key to decrypt the encrypted key element, which he did not possess (step 160). Using the decrypted key element, the recipient is able to generate the symmetric key (step 162) and decrypt the object (step 164). Hence, in the implementation discussed above, the recipient derives R using his decrypting half of the asymmetric key, and is then able to derive the symmetric key with p and g, which he already possessed.

In addition to this DAR encryption performed by OAC 108, network access control 110 implements another cryptographic function to secure the confidentiality of data-in-transit (“DIT”) at the Internet Protocol (“IP”) layer and protect against unauthorized connections. In one implementation, NAC 110 is an IP encrypting network device that provides Type 1 security and non-Type-1 security. The Type 1 security is preferably provided in accordance with the High Assurance Internet Protocol Interoperability Specification (“HAIPIS”).

The distribution, binding and availability of attributes (and their corresponding keys) is managed by policy management component 104. Policy management component 104 implements a rule based system in which distribution and management of keys are controlled by discrete policy rules. The discrete policy rules, in turn, are based on a set of credentials that is assignable to principles, or users, of the system. A principal is defined as any subject in the UIA system that can be enrolled in a given policy. Essentially, a principle is assigned one or more credentials which, in turn, entitle the principle to access various object and network attributes. As described above, each attribute has a one-to-one mapping with a cryptographic key. Hence, a recipient will be able to decrypt a received object only if he has attributes (which map to keys) matching those used by the sender to encrypt the object.

Policy management component 104 is configurable, in that there are no predefined templates in the data structures, and it is designed to provide a highly flexible system while maintaining support for traditional policy instantiations. Policy concepts are defined in terms of individually managed discrete policy components (credentials, attributes, etc.) that stand alone in definition and function. When the discrete components are combined, meaningful policy can be created and assigned.

In order to unlock data bound and protected by UIA system 100, a user must also present identification information to IAA component 106. In one implementation, IAA component 106 is strong 3-factor IIA component consisting of user biometrics, user PINs and user-held token devices.

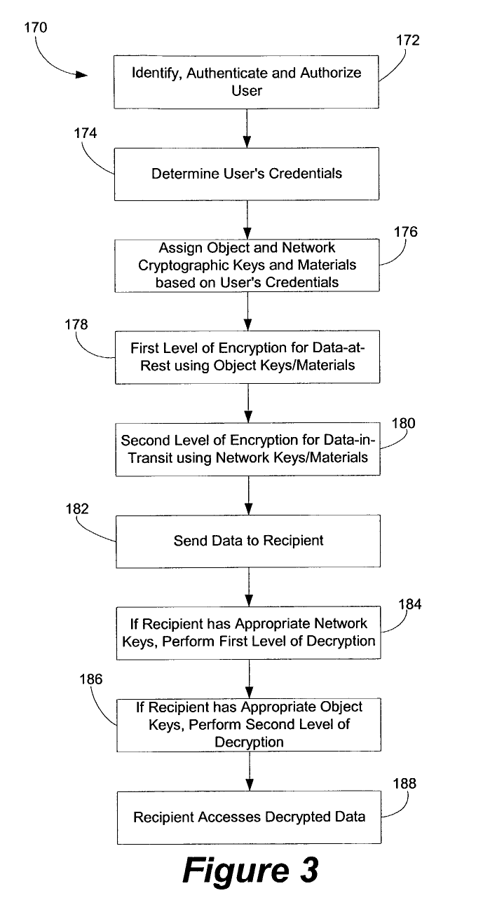

The overall operation 170 of UIA system 100 is depicted in FIG. 3. In step 172, a user wishing to access and use system 100 is identified, authenticated and authorized. This step is performed by IAA component 106. Next, in step 174, a user's credentials are determined and object and network cryptographic keys are assigned to the user based on the user's credentials (step 176). Steps 174 and 176 are performed by policy management component 104. Dual levels of encryption are then performed on a data object to be sent: in step 178, a first level of encryption is performed with the user's object keys; and, in step 180, a second level of encryption is performed with the user's network keys. As described with reference to FIG. 2, the object key encryption is itself a layered combination of symmetric and asymmetric encryption.

The encrypted data is sent to the recipient or to a common server in step 182. In step 184, the DIT encryption is first stripped from the object. This will be possible only if the recipient had the necessary credentials to obtain the required network keys and materials from policy management component 104. Next, in step 186, the DAR encryption is stripped from the object. Again, this is possible only if the recipient had the necessary credentials to obtain all required object keys and materials from policy management component 104. Finally, with DIT and DAR encryption removed, the recipient is able to access the data in step 188.

One Implementation of UIA

UIA system 100 can be implemented in any environment where secure communications are needed. An ideal candidate for implementation of UIA system 100 is the military and defense community. UIA could be employed to provide a secure communications environment on a ship, for example. The UIA implementation described herein was designed to interconnect and provide secure inter- and intra-government and government agency and organization lines of communication. It consists of a collection of functional services that provide access control to network and data resources, and data protection for the information that resides in those resources. It is one of many possible implementations of UIA system 100.

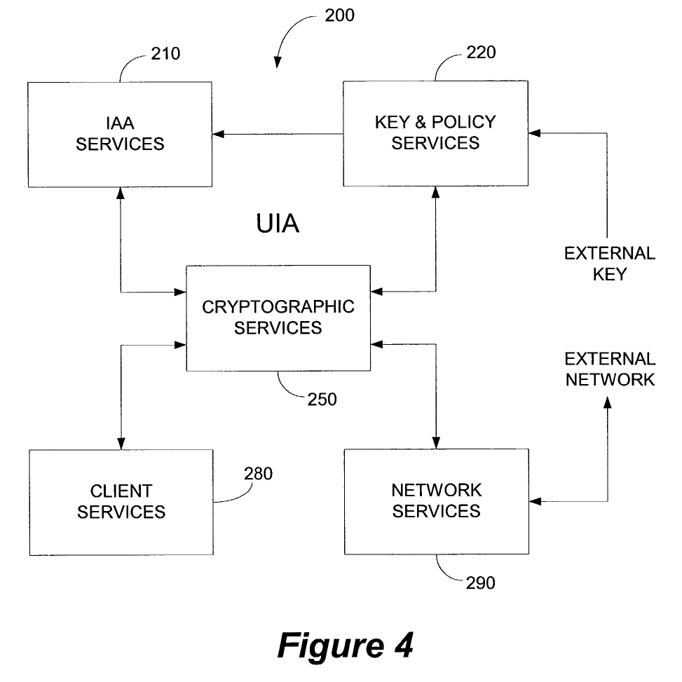

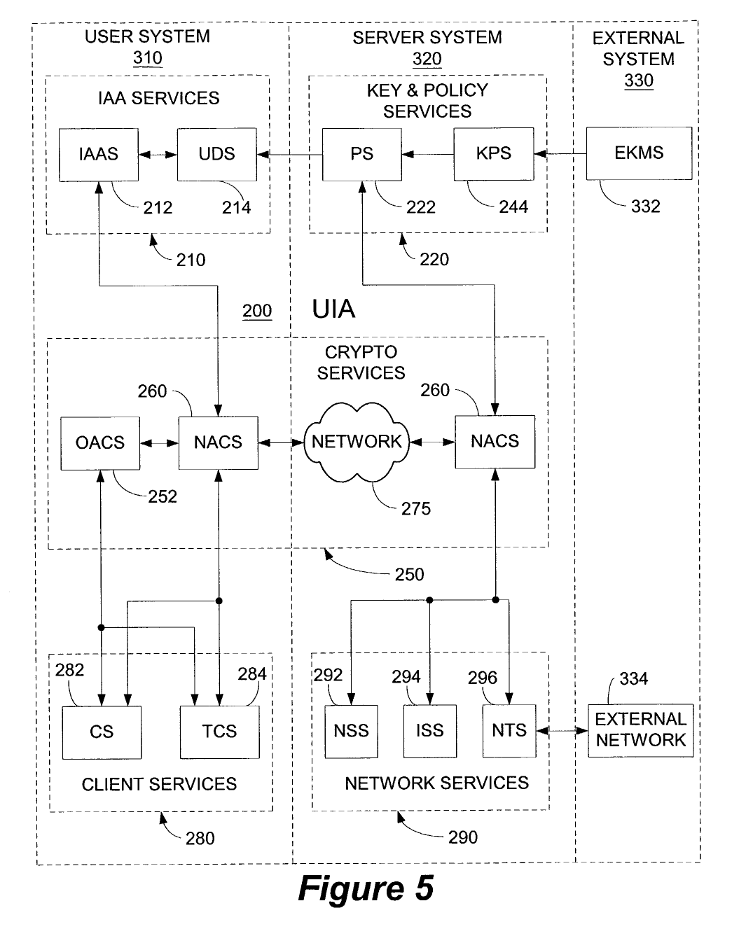

FIG. 4 is a system level block diagram of UIA system 200 showing the UIA system components and interconnections, and FIG. 5 illustrates system 200 and its subsystem components in more detail. Key and policy services component 220, cryptographic services component 250 and IAA services component 210 form the heart of system 200 and correspond, respectively, to previously-described UIA policy management component 104, access control component 102 and IAA component 106. System 200 also includes client services component 280 and network services component 290.

Key and policy services component 220 is implemented on server side 320 of system 200. It is responsible for implementing and managing policy and includes policy subsystem (“PS”) 222 for this purpose. Component 220 also includes key processing subsystem (“KPS”) 244. In one implementation, KPS 244 accepts selected external black keys and key materials from an external electronic key management system (“EKMS”) 332, processes the keys and provides them to PS 222. In the following description, “black” refers to encrypted and “red” refers to unencrypted (plaintext).

Cryptographic services component 250 implements the network and object access control functions of system 200. It includes object access control subsystem (“OACS”) 252 for implementing the cryptographic function to protect data-at-rest (DAR). The OACS resides on the user side 310 of system 200. The sending user encrypts objects with keys corresponding to object attributes, and a receiving user can decrypt the objects only if he possesses the proper credentials (and associated keys), as determined by policy subsystem 222. Network access control subsystem (“NACS”) 260 is present on both user 310 and server 320 sides of system 200. NACS 260 performs a second level of encryption (DIT) on data when it is ready to be sent over a network connection 275 and, vice-versa, decrypts any data received over a system network connection. Importantly, the DIT encryption provided by NACS 260 is in addition to the DAR encryption provided by OACS 252.

IAA services component 210 is implemented on user side 310 of system 200 and includes IAA subsystem (“IAAS”) 212 for identifying a user at login from his token, biometrics and PIN. Component 210 also comprises user data subsystem (“UDS”) 214, the hardware component of which is a user token. IAAS 212 inputs and processes the user's token, PIN and biometrics via a trusted path and trusted processor that is independent of the untrusted operating system of a user's workstation.

Client services component 280 is the interface to the common user's computing environment. It includes client subsystem (“CS”) 282, whose principle component is a user workstation, and trusted client subsystem (“TCS”) 284 for special functions such as regrading and publishing. Network services component 290 includes network storage subsystem (“NSS”) 292 for storing OAC encrypted objects, network translation subsystem (“NTS”) 294 for facilitating data retrieval from external networks 334 and infrastructure support system (“ISS”) 296 for facilitating intra-system network and email operations.

Policy Construct and Data Structure

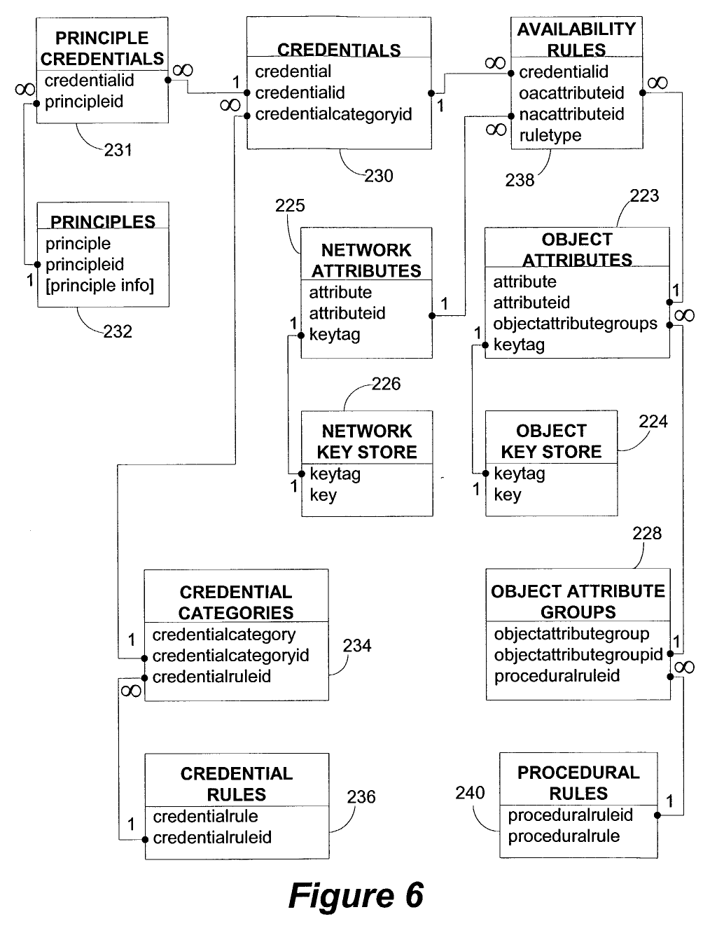

Policy is implemented by policy subsystem 222 residing in component 320. Policy subsystem 222 centrally manages policy origination, policy tailoring, key management and user enrollment. Subsystem 222 also records all system level audit events. To facilitate these functions, subsystem 222 relies on a central data structure for core operations. One embodiment of a policy data structure, comprising linked tables of data, is illustrated in FIG. 6. It should be noted that this is just one embodiment of a policy data structure. Other data structures may be devised and utilized to implement the principles of the present invention.

In FIG. 6, a “1” at the end of a link indicates that there is only one item in that table that links with item(s) in the linked table. A “∞” at the end of a link indicates that there can be multiple items in that table that link with item(s) in the linked table. Also, with respect to the discussion of FIG. 6, the term “key” is used in a database management sense (i.e., a key is a field used to sort data) and not in a cryptography sense unless a key is specifically indicated as being a cryptographic key.

Attributes

At the heart of the policy system are two basic entities: object attributes and network attributes. These two entities are similar, in that they each have a one-to-one mapping with a specific cryptographic key. Network attributes are assigned to and protect network resources, and object attributes further segment these resources by content. The common name assigned to an attribute is referred to as an attribute label, and the corresponding cryptographic key is referred to as an attribute key. Object attribute keys are used to encrypt persistent data (“data-at-rest”), and network attribute keys are used to encrypt data-in-transit. Hence, the assignment of attributes and the corresponding availability of attribute keys defines a specific security policy. Table 1 shows the relationship between attributes and keys.

TABLE 1
Attributes and Cryptographic Keys

| Attribute | Cryptographic Key |
|---|---|
| Object Label: DEA WRITE | Object Key: 101001011101010 |
| Object Label: FBI READ | Object Key: 101101011101011 |
| Network Label: SECRET NET- | Network Key: 101111011101010 |
| WORK | |
| Network Label: INTERNET | Network Key: 111011011101011 |

In FIG. 6, object attributes table 223 stores data fields relating to object attributes. For each object attribute, there is an “attribute” text field that stores the object label corresponding to that object attribute; an “attributeid” field that is the table's primary key; an “objectattributegroups” field that is a numeric foreign key linking to an object attribute group in table 228; and a “keytag” field that has a one-to-one mapping to a cryptographic key stored in object key store 224.

For each object attribute stored in table 223, there is a corresponding cryptographic key (black or encrypted) stored in object key store 224. For each cryptographic key in store 224, there is a “key” binary number field containing an actual key (encrypted); and a “keytag” field that is the table's primary key having a one-to-one mapping with the “keytag” field of one object attribute in table 223.

Network attribute table 225 stores the data fields relating to network attributes. For each network attribute, there is an “attribute” text field containing the network attribute label corresponding to the network attribute; an “attributeid” field that is the table's primary key; and a “keytag” field that has a one-to-one mapping to a cryptographic key stored in network key store 226.

For each network attribute stored in table 225, there is a corresponding cryptographic key (encrypted) stored in network key store 226. For each cryptographic key stored in store 226, there is a “key” binary number field containing an actual key (encrypted), and a “keytag” field that is the table's primary key having a one-to-one mapping with the “keytag” field of one network attribute in table 225.

Object Attribute Groups

To facilitate easy reference and to support the concept of run time rules, object attributes are grouped under common category titles. The titles allow other policy members to refer to the group title in place of the individual attribute labels. Group titles do not have a cryptographic key association. Only object attributes, and not network attributes, have attribute group titles. Table 2 is an example of the relationship between object attribute groups, object attribute labels and attribute keys.

TABLE 2
Object Attribute Groups

| Object Attribute Group | Object Attribute Label | Attribute Key |
|---|---|---|
| CLASSIFICATION | SECRET READ | 1101010101101001 |
| | UNCLASS WRITE | 1010101011110000 |
| COUNTRY | USA READ | 1000010101010101 |
| | GBR WRITE | 1110010100101010 |

Object attribute groups table 228 stores the data fields relating to object attribute groups. For each object attribute group, there is an “objectattributegroup” text field containing the title of the group; and an “objectattributegroupid” field that is the table's primary key. The “objectattributegroupid” field links to the “objectattributegroups” field of object attributes table 223 in order to link object attribute groups with the object attributes within the group. Since most groups will contain more than one attribute, an attribute group in table 228 is typically linked to multiple attributes within table 223. Each attribute within table 223, however, is linked to only one attribute group. Attribute group table 228 also includes a “proceduralruleid” foreign key field that links to procedural rules table 240. Procedural rules will be described in more detail herein.

Credentials

Credentials are assignable properties given to principals (users). Stated another way, credentials are the policy component that can be assigned to users. Credentials do not directly map to a cryptographic key; that function is reserved solely for the attribute component. The relationship between a given credential and an attribute is called an availability rule. In general, there are two rule types in UIA system 200: procedural (runtime) rules and availability rules. Credentials can reference assigned attributes by excluding or including the attributes when the credential is in use.

A credential is typically assigned a common label that represents a quality that the user owns, possesses or is assigned (e.g., rank, role, clearance, nationality, membership). The credentials are the assigned to users in a process referred to as “enrollment”. As an example of enrollment, a given user might be assigned the following credentials: “USA”, “captain”, “NSA” and “top secret”. These four assigned credentials tell the policy something about the user. This information is then translated into available attributes according to the availability rules, which will be discussed below. Table 3 sets forth a sample group of users and the credentials that they have been assigned.

TABLE 3
Credentials

| User | Credentials |
|---|---|
| Frank Roberts | USA |
| | Top Secret |
| | Captain |
| | NSA |
| Jerry Perez | GBR |
| | Secret |
| | Captain |
| | M16 |
| Gray Johnson | KOR |
| | Unclassified |
| | Admiral |
| | Navy |

Credentials table 230 stores the data fields relating to credentials. For each credential, there is a “credential” text field containing the text label of the credential; a “credentialid” field that is the table's primary key; and a “credentialcategoryid” foreign key field that links to credential categories table 234. Principles table 232 stores the data fields relating to principals. For each principal (user), there is a “principal” text field for that contains the name or identity of the principal (user) and a “principalid” primary key field. Principles table 232 can also support additional fields containing data or information relating to the principles.

Principle credentials table 231 is a join table linking credentials table 230 and principles table 232 and permitting many-to-many relationships between the two tables. One principal may have many credentials and, vice-versa, one credential may be assigned to many principals. The two data fields of table 231, “credentialid” and “principleid”, are foreign keys linking to the credentials and principles tables.

Credential Categories

Credential categories provide groupings for similar credentials and a mechanism for associating credential category rules (described below) with a particular policy implementation. Credential categories can also serve as the basis for the creation of assignable credentials. Table 4 illustrates the relationship between credentials and credential categories.

TABLE 4
Credential Categories

| Credential Category | Credentials |
|---|---|
| Rank | Private |
| | Corporal |
| | Lieutenant |
| | Captain |
| Nationality | USA |
| | CAN |
| | RUS |
| | KOR |
| Clearance | Top Secret |
| | Secret |
| | Confidential |
| | Unclassified |

Credential categories table 234 stores the data fields relating to credential categories. For each credential category, there is a “credentialcategory” text field containing the title of the category; and a “credentialcategoryid” primary key field. The “credentialcategoryid” field links to the “credentialcategoryid” foreign key field of credentials table 230 in order to link credential categories with the credentials belonging to that category. Since most categories will contain more than one credential, a credential category in table 234 is typically linked to many credentials in table 230. Each credential in table 230, however, is linked to only one credential category. Category table 234 also includes a “credentialruleid” foreign key field that links to credential rules table 236.

Credential Category Rules

Credential category rules dictate how multiple credential assignments within the same category are handled. When multiple credentials from the same category are assigned, the system references the applicable category rule in order to resolve the ambiguity. Credential ambiguity resolution is typically done during login. In one implementation, there are three credential category rules: enrollment, environment and user. If a credential category does not have an associated category rule, then multiple credential assignments within the same category are not permitted.

When the applicable category rule is set as “user”, the user must choose one and only one of the assigned credentials from the category at issue before logging onto the system. An example of a credential category that might use the user category rule is role: a user can operate in the role of a reader or in the role of a publisher (and hence have both reader and publisher credentials), but not at the same time. If the credential category rule is user, the ambiguity is resolved at login by requiring the user to select either the reader or publisher credential.

When the applicable category rule is set as “enrollment”, the system combines the assigned credentials. In other words, the user is given access to both credentials at runtime. An example of a credential category that might use the enrollment category rule is membership: a user might be a member of Project ABC and Project XYZ (and hence have credentials for both projects). If the credential category rule is set as enrollment, the ambiguity is resolved at login by allowing the user to keep and access the credentials for both projects.

When the applicable category rule is set as “environment”, a trusted environment supplies information to resolve the ambiguity. In one implementation, TCS 284 supplies information about the current environment to permit PS 222 to make an appropriate credential selection. An example of a credential category that might use the environment category rule is location: a user might have credentials for both secured and unsecured facilities. If the credential category rule is set as environment, the ambiguity is resolved at login by information supplied about the current environment. For example, a user might be permitted to login at a SECRET level while in a secured facility, but not while in an unsecured facility. Table 5 sets forth examples of credential category rules in action. The credential categories, credentials and category rules shown in Table 5 are illustrative only and are not meant to restrict the range of categories, credentials or rules that can be implemented by the invention.

TABLE 5
Credential Category Rules

| Credential | | | |
|---|---|---|---|
| Category | Credentials | Category Rule | Notes |
| Rank | Captain | None | Multiple credentials |
| | Lieutenant | | not allowed. Users |
| | Corporal | | cannot hold two |
| | | | simultaneous ranks |
| Nationality | USA | Enrollment | Users holding dual |
| | CAN | | citizenship get both |
| | RUS | | credentials at once |
| Location | Secured Facility | Environment | Different policies |
| | Unsecured Facility | | available depending |
| | | | on location |
| Role | Publisher | User | User can hold |
| | Regrader | | multiple credentials |
| | | | but must select one |
| | | | at login |

Credential rules table 236 stores the data fields relating to credential rules. For each credential rule, there is a “credentialrule” text field that is the name or title of the rule and a “credentialruleid” primary key field that links to the “credentialruleid” foreign key field of credential categories table 234. The link from table 236 to 234 is one-to-many: one rule may apply to many categories but each category has only one rule.

Availability Rules

The availability of an attribute based on a given credential is controlled by an availability rule. When dealing with availability rules it is important to understand the distinction between attributes and credentials. Attributes have a one-to-one mapping with a cryptographic key. Credentials, conversely, can represent one or more attributes and do not have a one-to-one relationship with a particular key. Credentials map to attributes by including-or excluding particular attributes. A credential can-include some attributes and exclude others. Table 6 demonstrates the relationship between credentials, availability rules and attributes.

TABLE 6
Availability Rules

| Category: Credential | Availability Rule | Attribute |
|---|---|---|
| Rank: Captain | Includes: | Officer Attribute |
| Clearance: Secret | Includes: | Unclassified Attribute |
| | | Confidential Attribute |
| | | Secret Attribute |
| | Excludes: | Top Secret Attribute |
| Clearance: Confidential | Includes: | Unclassified Attribute |
| | | Confidential Attribute |
| | Excludes: | Top Secret Attribute |
| | | Secret Attribute |
| Location: unsecured facility | Excludes: | Top Secret Attribute |
| | | Secret Attribute |

Where availability rules intersect, exclusion holds higher order than inclusion. For example, in Table 6, a user with a secret clearance credential would not get assignment of a secret attribute in an unsecured facility, but would get assignment of a secret attribute in a secured facility.

Availability rules table 238 is a join table linking credentials table 230 to object attributes table 223 and network attributes table 225 and permitting many-to-many relationships between the tables. One credential may give rise to the availability of several attributes and one attribute may be available to multiple credentials. Table 238 contains three foreign key fields: “credentialid” links to credentials table 230; “oacattributeid” links to object attributes table 223; and “nacattributeid” links to network attributes table 225. Availability rules table 238 also includes a “ruletype” field that contains a boolean value to implement the availability rule associated with a particular credential.

Procedural Rules

Procedural rules can be assigned to object attribute groups to help the run time environment display meaningful policy selections to users. They are intended to keep users from marking and labeling objects in an unstructured manner. They are considered usage rules (not attribute availability rules), set up at policy creation and enforced on the user workstation (CS 282). Because the rules are enforced in a potentially untrusted environment, they should be used only to suggest usage to the user.

As an example of a procedural rule, if a user is given a “USA-Write” key and a “SECRET-Write” key, and he intends to publish a SECRET document for USA viewing only, he should select SECRET and USA. The appropriate procedural rule is: “follow the SECRET key selection with the USA key selection.” Following the rule will result in a double encryption of the random vector in the DAR object encryption key so that only recipients having both read keys will be able to decrypt it. Note, however, that the procedural is not cryptographically enforced by the system; it is up to the user to follow the rule properly (the rule is only suggested usage). As an alternative to procedural rules, in order to avoid the risk of a user failing to follow through properly in this scenario, he could be given only the single key “SECRET-USA-Write”. A tradeoff between fewer keys with more procedural rules and more keys with less procedural rules is involved.

Table 7 illustrates the relationship between object attribute groups and procedural rules.

TABLE 7
Procedural Rules

| Object Attribute Group | Attribute | Procedural Rule |
|---|---|---|
| Classification | Secret | Selection should be made |
| | | before subsequent |
| | | selections |
| Releasability | CAN | Selection should follow |
| | RUS | classification |

Procedural rules table 240 stores the data fields relating to procedural rules. For each procedural rule, there is a “proceduralrule” text field that is the name or title of the rule and a “proceduralruleid” primary key field that links to the “proceduralruleid” foreign key field of object attributes group table 228. The link from table 240 to 228 is one-to-many: one procedural rule may apply to many attribute groups but each group has only one rule.

Policy Subsystem Operation and Structure

Before discussing the details of policy subsystem operation, an important distinction is noted between policy creation/management and use of a policy for access control. The policy subsystem does not have a mechanism for cryptographically combining keys. There are no AND'ing or OR'ing functions during policy creation, management and assignment. Rather, the policy subsystem will tell the object access control subsystem which attribute keys a user is entitled to based on his credentials. It is the access control subsystem that manipulates the keys to appropriately encrypt an object.

Policy Creation and Management

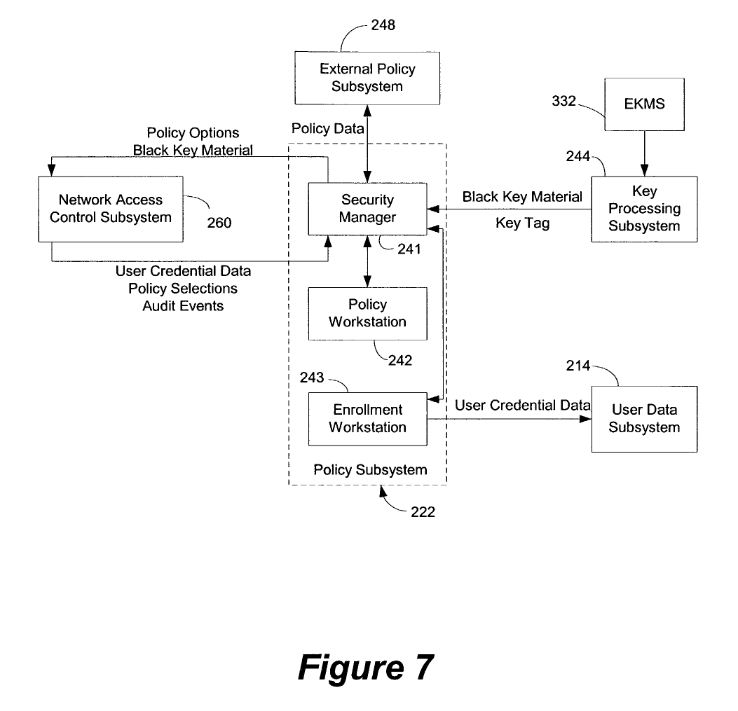

The various operations and functions performed by policy subsystem 222 are shown in FIG. 7. In one embodiment, the principle physical components of policy subsystem 222 are security manager or server 241, policy workstation 242 and enrollment workstation 243. Before system 200 can operate, a policy must be present in security manager 241. The policy may either be created locally, via policy workstation 242, or imported from an external policy subsystem 248. Policy data imported from an external policy subsystem will typically include predefined attributes, credentials and rules associated with policy objects. Imported policy will also typically include rules governing the amount of tailoring allowed by the local policy subsystem 222. In one embodiment, the policy is present in the system in a data structure as described above. Once created, policy is managed from policy workstation 242, which preferably provides a comprehensive user interface.

User Enrollment

Once a policy is present in subsystem 222, principals must be enrolled in the policy data structure. Subsystem 222 includes one or more enrollment workstations 243 that allow users to access and enroll in the policy held by security manager 241. At enrollment workstation 243, an enrollee presents user data subsystem (UDS) 214, the hardware aspect of which is a token, along with his credentials, biometrics (in one embodiment fingerprints) and identification information (in one embodiment, a PIN). If the policy subsystem approves the user's credentials, it writes token data to the user's token (UDS). In one implementation, the token data includes a hashed user ID, a hashed user PIN, fingerprint templates (biometrics), the token size and other information such as the user's name, photograph and citizenship.

In one embodiment, policy subsystem 222 supports a two-person enrollment policy. Enrollments are provisionally approved by an enrollment officer and/or the security manager 241, but remain pending and cannot be activated until approved by a designated security administrator. In this manner, a single user cannot compromise the enrollment process.

User Login and Authentication

Policy subsystem 222 interfaces with network access control subsystem 260 to support login by enrolled users. This process will be described in detail in connection with IAAS 212. Briefly, at login, a user presents his PIN, biometrics and token to the IAAS at his workstation. The IAAS verifies the PIN and biometrics and provisionally verifies the token. If accepted, the user ID and token details are sent to the policy subsystem for final authentication. If authenticated, the policy subsystem uses the user ID to retrieve the user's credentials. If the user has any policy options, these are presented to the user for response. The policy subsystem applies the availability rules based on the user's credentials and policy selections, determines what attributes are available, and returns the appropriate network and object attribute keys (encrypted) to the user. Again, this process will be described in more detail in a later section of this specification.

Key Distribution

A final, critical function performed by policy subsystem 222 is acting as a central distribution point for black (encrypted) key material. The black key material is provided to policy subsystem 222 by key processing subsystem 244. This key material and its association with policy objects are stored in the policy data structure. Once an enrolled user is logged in and authenticated by the policy subsystem, and only then, the black key material is released to the object access and network access control subsystems of cryptographic services component 250.

Key Processing Subsystem

Key Processing Subsystem (KPS) 244 serves as a processor of cryptographic keys and an interface between policy subsystem 222 and an external Electronic Key Management System (EKMS) 332. KPS 244 accepts the following black (encrypted) keys from EKMS 332: traffic encryption key generation material (TGM), used for network access control (DIT encryption); and asymmetric keys (SE(J) and SD(J), prime modulus “p” and primitive element “g” series, used for object access control (DAR encryption). KPS 244 accepts the black keys from EKMS 332, tags the keys (hiding any external key tags) and passes them on to PS 222.

Key Definitions

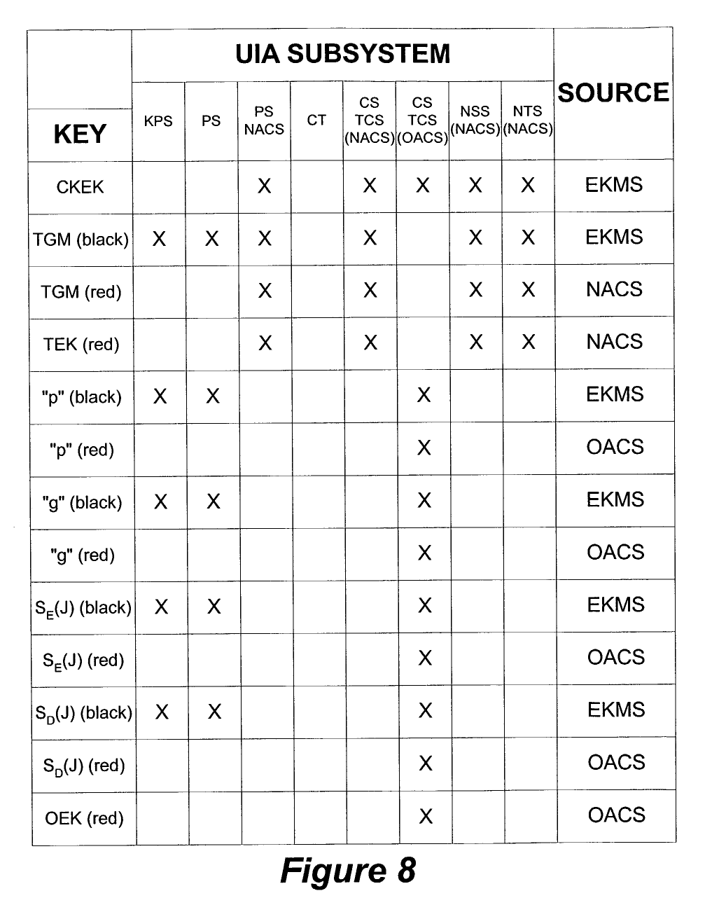

Before describing the object and network access control subsystems, the various types of keys and key materials that are used by those subsystems will be described. A table identifying the types of keys and key materials used in system 200 and the components that use those keys is depicted in FIG. 8. The black (encrypted) and red (plaintext) versions of the keys are separately indicated.

Community Key Encrypting Key (CKEK)

The community key encrypting key (“CKEK”) is a key that is used exclusively for encrypting and decrypting keys. All keys used within UIA system 200 are themselves encrypted/decrypted using the CKEK. Each UIA system (the total aggregation of interoperable, or potentially interoperable, UIA elements) has its own CKEK. The purpose of the CKEK is to isolate UIA systems of one organization or government from UIA systems of other organizations or governments that have no need to interoperate.

The CKEK is preferably installed into non-volatile memory within the protected information security (“INFOSEC”) boundary of each cryptographic subsystem within a system 200. All interoperable cryptographic systems in a community must have the same CKEK. If a cryptographic subsystem is moved from one community to a different community, a new CKEK must be installed. The CKEK, once installed, persists indefinitely.

Traffic Encryption Key (TEK)

Traffic encryption keys (“TEKs”) are non-persistent, symmetric keys used to DIT-encrypt traffic at the IP (network) layer (network access control). TEKs are developed within network access control subsystem 260 using TEK generation material (“TGM”) downloaded from policy subsystem 222. Once generated, TEKs are present in red (plaintext) form only and persist only for one login session. In one implementation, TEKs are implemented in accordance with the Interoperability Specification for High Assurance Internet Protocol Encryptor (“HAIPE”) devices.

TEK Generation Material (TGM)

TEK generation material (“TGM”) consists of values used to generate the symmetric TEKs used for DIT encryption/decryption (network access control). In one implementation, for Type 1 cryptography, these values are FIREFLY vectors. Network access control subsystems within a common UIA system use compatible TGM. Incompatible TGM between different UIA networks prevents inter-network communication at the IP layer.

CKEK-encrypted (black) TGM originates in electronic key management system (“EKMS”) 332, passes through key processing subsystem 244 and is stored in encrypted format on policy subsystem 222 (in network key store 226) where it is tagged with unique key tags. When an IAA-validated user logs into system 200, the encrypted TGM for the network that he selects is downloaded to the NACS 260 associated with his workstation and is decrypted using the CKEK. The decrypted (red) TGM is then used in cooperation with another NACS that has compatible TGM to generate symmetric session TEKs. The decrypted TGM persists for only one login session.

Prime Modulus (“p”)

The value “p” is an ANSI (American National Standards Institute) X9.42 prime modulus used for DAR-encryption (object encryption). It is one of the “key elements” described with reference to FIG. 2. The black (CKEK-encrypted) value of “p” originates in an EKMS 332 and passes through KPS 244 to PS 222 where it is stored. It is sent to OACS 252 in a user's workstation following successful IAA and policy selection, and decrypted using the CKEK to be used to generate the object encryption key (“OEK”). The red value of “p” persists for only one login session.

Primitive Element (“g”)

The value “g” is a primitive element mod p used for DAR-encryption. It is another of the “key elements” described with reference to FIG. 2. The black (CKEKencrypted) value of “g” originates in an EKMS 332 and passes through KPS 244 to PS 222 where it is stored. It is sent to OACS 252 in a user's workstation following successful IAA and policy selection, and decrypted using the CKEK to be used to generate the object encryption key (“OEK”). The red value of “g” persists for only one login session.

Each value of “g” is a member of a one-way hashed series that, when used in reverse order, enables a DAR security domain to be “rolled over” such that selected individuals can be locked out of the domain while preserving the ability for remaining domain members to decrypt documents encrypted with the old value of “g”. A separate g-series is used for each different “p” value. Also, since “g” must be a primitive element mod p, other g-values in the hash sequence must be preserved to maintain the hash sequence, but not used. To illustrate this concept, let H(X)=a one-way non-compressing hash of X. If Xₙ₊₁=H(Xₙ), then Xₙ₊₁ is relatively easy to compute, given Xₙ. The reverse, however, is not true: the computation of Xₙ₋₁, given Xₙ, is computationally difficult.

The EKMS 332 pre-computes and archives a series of g values that are iterative hashed values of an initial value:

g_{N-3}=H(g_{N-2});

g_{N-2}=H(g_{N-1});

g_{N-1}=H(g_{N); etc.}

If the value g_{N-2} is in use today, the value of g_{N-3} that was used previously can be computed (for decrypting historical data), but the future value g_{N-1} that will be used after the next key rollover cannot be computed.

Asymmetric Key Pair (S_{E}(J) and S_{D}(J))

The asymmetric key pair S_{E}(J) and S_{D}(J) is used to encrypt/decrypt a random value R that is used in DAR-encryption. KPS 244 receives black (CKEK-encrypted) versions of each key in this asymmetric pair and passes them to PS 222 where they are stored (in object key store 224) and tagged with unique key tags. The enrollment officer, using a policy terminal, stores pointers to selected values of SE(J) and SD(J) on each user's token and stores associated pointers to these keys in the policy subsystem database. Only pointers to the keys, and not the actual keys, are stored on the user's token. A user is given access to keys in domain J only if he is a member of domain J. Also, users who are members of domain J are still not necessarily given access to both the encrypt S_{E}(J) key and decrypt S_{D}(J) key. The encrypt and decrypt keys are granted selectively to users on a need-to-use basis.

Possession of pointers to the S_{E}(J) key and/or the S_{D}(J) on a user's token is not sufficient for DAR encryption/decryption. The keys must also be downloaded from policy subsystem 222, which occurs only after a successful IAA login and user-selection of a NAC network and user role. Red S_{E}(J) and S_{D}(J) keys are produced in OACS 252 by decrypting the black S_{E}(J) and S_{D}(J) keys using the CKEK. The red keys are then used to encrypt/decrypt the random value R used to produce the OEK. The red keys never leave the INFOSEC boundary of OACS 252 and persist for only one login session.

Object Encryption Key (OEK)

Red (plaintext) object encryption keys (“OEKs”) are produced within the INFOSEC boundary of OACS 252 and are used to encrypt or decrypt a single object (file). OEKs are symmetric and provide object access control (OAC). Although an OEK is symmetric, it is based on the asymmetric keys S_{E}(J) and S_{D}(J) to independently control read and write access to CBIS objects. The OEK for an object is computed as follows:

OEK(J)=g^{R} mod p

Where

g=a primitive element mod p in a one-way hashed series;

R=a type 1 hardware-based random generated within the OACS; and

p=an ANSI X9.42 prime modulus.

An OEK generated within an originator's OACS must be recreated within each intended recipient's OACS. Qualified recipients are given “g” and “p” by policy subsystem 222 following successful IAA login, and the random component R is transmitted, in encrypted form, along with the object. R is encrypted using the asymmetric key S_{E}(J) and incorporated into the metadata that forms a header for the encrypted object.. The metadata is stored in plaintext format along with the encrypted object in order to support decryption of the object by a qualified recipient. It is also encrypted along with the object as a means to confirm that the plaintext version has not changed.

When the encrypted object with its plaintext metadata is downloaded to a recipient user, the user's OACS decrypts the encrypted R in the metadata using his asymmetric key S_{D}(J) corresponding to the R-encrypting key S_{E}(J). Once R has been decrypted, the object encryption key is computed as:

OEK(J)=g^{R} mod p

OEK(J) is then used to decrypt the encrypted object.

Encrypting the random vector R with a single encryption key SE(J) makes the object viewable only by members of domain J. Object access control can be expanded by encrypting the random vector R with the encryption key for all desired domains. For example, to make an object viewable by security domains CAN and GBR, the random vector R is separately encrypted for both CAN and GBR (i.e. an encryption operation is performed on R by the encryption key S_{E}(CAN), and a separate encryption operation is performed on R by the encryption key S_{E}(GBR)). Both of the encrypted values of R are included in the metadata, permitting a holder of a decryption key in either the CAN or GBR domain to decrypt R and compute the object decryption key. The object is still encrypted only once; only the random R is encrypted twice with different keys. This permissive expansion of object access control is equivalent to a Boolean ‘OR’ function.

Object access control can be restricted to a subset of a domain by recursively double encrypting the random R with both the domain key and the subset key. For example, to make an object viewable by only the FBI subset of the USA, the R vector is first encrypted with the S_{E}(USA) key, and this encrypted R is then encrypted again with the S_{E}(FBI) key. Only a holder of both the S_{D}(USA) and SD(FBI) decryption keys will be able to decrypt the random vector R from the metadata and compute the object decryption key. This recursive encryption using different keys can be extended indefinitely and, again, the object is encrypted only once. It is the equivalent of a Boolean ‘AND’ operation.

Boolean combinations of the permissive expansion (OR) and restrictive contraction (AND) operations are supported by UIA system 200.

Network Access Control Subsystem

Network Access Control Subsystem (“NACS”) 260 implements the cryptographic function that protects data-in-transit at the IP layer in network 200. In one embodiment, NACS 260 is an IP networking device that provides Type 1 security and non-Type 1 security. Preferably, the NACS Type 1 security is a HAIPIS variant of IP security services for Type 1 security. The HAIPE interoperability specification mandates many details of NACS functionality regarding key management, device management, network protocols, tunnel endpoint discovery, connection negotiation and communications traffic.

Initially (prior to normal operation), NACS 260 interfaces with EKMS 332 to load a red (unencrypted) CKEK and black pre-placed traffic generation material (TGM_PPK). These keys never leave the INFOSEC boundary inside NACS 260 and are required for NACS operation. The TGM_PPK keys are decrypted with the CKEK and used, preferably in a HAIPE-variant Internet Key Exchange (“HIKE”), to set up a secure tunnel with policy subsystem 222. In one implementation, the pre-placed TGM_PPK key material comprises FIREFLY vector sets for Type 1. There are no pre-placed keys for non-type 1; they are negotiated with IKE using public values.

After user authentication NACS 260 receives the black TGM necessary to generate a traffic encryption key (TEK) for network access. NACS 260 reads the tags accompanying the black TGM and decrypts the black TGM with the CKEK. NACS 260 then performs the HIKE protocol with another NACS on the UIA network to set up traffic encryption keys in a secure and authenticated manner. At user logout, NACS 260 deletes all key material except for the CKEK and the TGM_PPK.

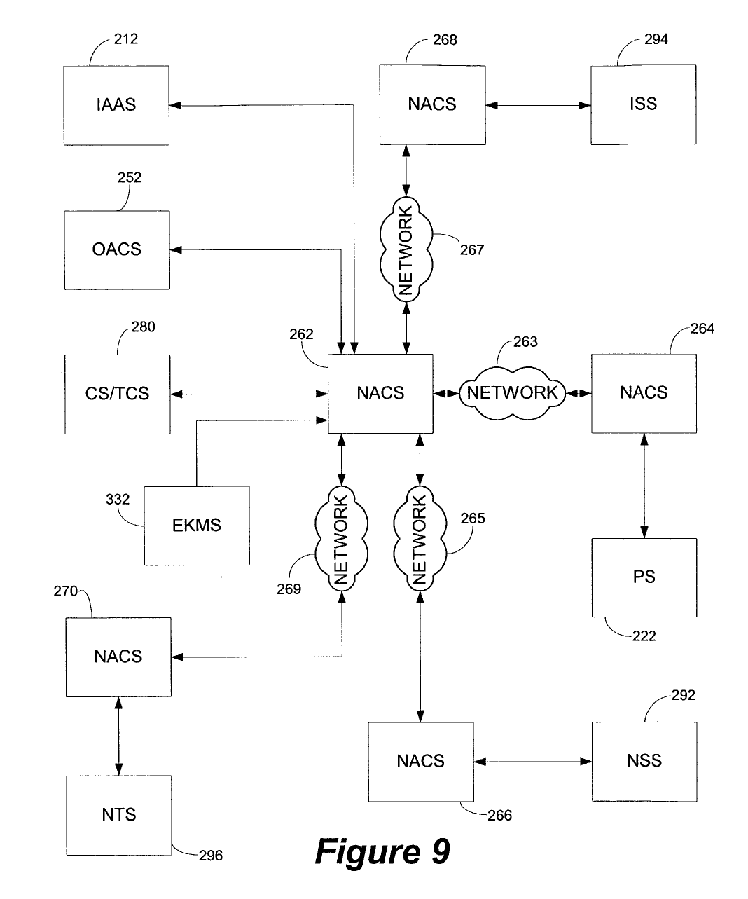

The interfaces between multiple NACSs and other components within UIA system 200 are depicted in FIG. 9. While individual NACSs are separately numbered for ease of reference, the function of each is the same as described with respect to NACS 260 above. NACS 262 fronts client or trusted client subsystem (collectively, “CS”) 280. As previously described, before the first operation of system 200, NACS 262 interfaces with external EKMS 332 or other external key system to load a red CKEK and black TGM_PPK. NACS 262 interfaces with other NACSs that front subsystems on the UIA network to set up secure tunnels for network communications. These secure tunnels are referred to as “black” tunnels, and in one implementation are set up in accordance with a HIKE.

NACS 262 sets up a secure tunnel 263 through HIKE with NACS 264 fronting policy subsystem (PS) 222 for user login and audit event notification. During user login, NACS 262 sends user credential data, policy selection and audit events from IAAS 212 to NACS 264 for dissemination to PS 222. NACS 262 receives from NACS 264 the policy options available to the user and the black key material associated with the user credentials. NACS 262 also sets up a secure tunnel 265 using a HIKE exchange with NACS 266 fronting network storage subsystem (“NSS”) 292 for object retrieval and object posting. A secure tunnel 267 is set up between NACS 262 and NACS 268 fronting infrastructure support subsystem (“ISS”) for e-mail exchange. This set up can be initiated by either NACS. Secure tunnel 269 is set up between NACS 262 and NACS 270 fronting network translation system (“NTS”) 296 for the transfer of external or legacy data (i.e., object data). Again, this set up can be initiated by either NACS.

NACS 262 interfaces with IAAS 212 to receive the logout command, which the IAAS issues upon detection of removal of user token 214. The logout command is forwarded to OACS 252. NACS 262 also interfaces with OACS 252 to receive DARencrypted object data for posting to NSS 292 via secure tunnel 265, and NACS 262 receives DAR-encrypted objects retrieved from NSS 292 via secure tunnel 265 to be sent to OACS 252 for storage. Since there is no direct connection between OACS 252 and IAAS 212, NACS 262 functions as a go-between to transfer object file display data originating from OACS 252 destined for the IAAS 212 display to the user and, vice versa, to transfer user object file commands from IAAS 212 to OACS 252.

When e-mail is sent with an attachment, NACS 262 interfaces with OACS 252 to send an object file request that identifies the e-mail object file attachment so that OACS 252 can send the DAR-encrypted object data with its clear text metadata header to NACS 262 for incorporation into the e-mail. When e-mail is received with an attachment, NACS 262 interfaces with OACS 252 to send DAR-encrypted object data with its clear text metadata header to be stored on OACS 252. OACS 252 can decrypt the object upon request from CS 280 and then pass the plaintext object data to CS 280.

Object Access Control Subsystem

Object Access Control Subsystem (OACS) 252 implements the cryptographic function that protects data-at-rest (DAR) in network 200. After user authentication and policy determination, OACS 252 receives the black prime modulus “p” and black primitive element “g” used to generate the object encryption key (OEK), as well as selected black asymmetric keys SE(J) and SD(J) for encryption/decryption of the random value R that is also necessary to generate the OEK. The CKEK is used to decrypt the black keys and key materials for object encryption/decryption. These materials remain within the OACS INFOSEC boundary and are destroyed after user logout.

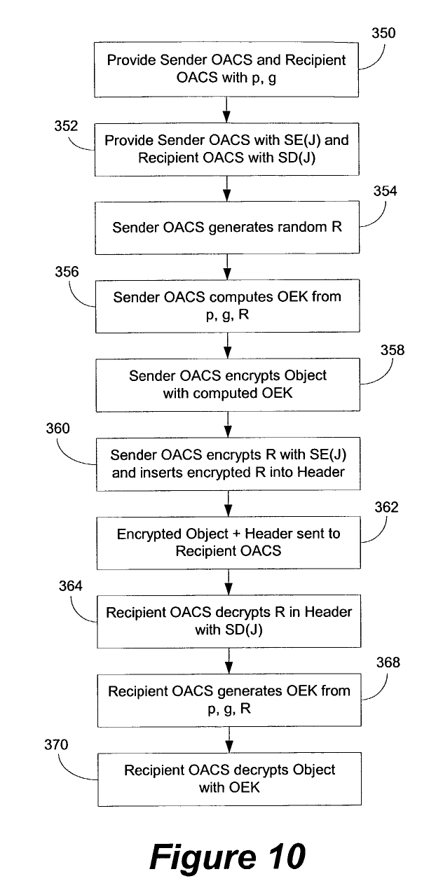

FIG. 10 illustrates the steps for object or DAR encryption and decryption. It should be noted that the method steps of FIG. 10 are a specific implementation of the more general inventive method set forth in FIG. 2. OACS 252 receives red (unencrypted) objects from client services component 280. Once a user desiring to store or send an object is authenticated, he is provided in step 350 with the prime modulus “p” and primitive element “g”. These key materials were discussed in detail above in connection with the key definitions, and are provided from PS 22 via the NACS as also described earlier. The OACS of a recipient having appropriate credentials is also provided with matching “g” and “p” in this manner. In step 352, the sending user is provided with the encrypting half SE(J) of an asymmetric key pair, while the recipient user must receive the decrypting half SD(J).

Next, in step 354, the storing or sending user OACS generates a random number R. In one implementation, R is a type 1 hardware-based random value. The OEK for a domain J can then be computed as OEK=g_{R} mod p (step 356), and the object is encrypted using the OEK (step 358). The random number R is then encrypted with S_{E}(J) and inserted into the metadata or header attached to the object. The metadata, with the exception of the encrypted R, is in plaintext. In one embodiment, the metadata includes matter descriptive of the encrypted object such as the object filename, title, author, subject, creation date, publication date, classification, keywords, a hash of the object, a hash of the encrypted R and the encrypted R.

The encrypted object may be stored at the OACS, which will typically include a hard disk for DAR-encrypted object storage. It may also be posted to network storage subsystem (NSS) 292 utilizing the NACS and DIT-encryption as described. As shown in step 362, the encrypted object and plain text header may also be sent to a recipient OACS. In this step, the NACSs of the sending and receiving users will establish a secure tunnel and use DIT encryption as previously described. The recipient OACS downloads the encrypted object and plaintext header, and decrypts R using SD(J) (step 364). The OEK can then be generated from p, g and R (step 366), and the encrypted object decrypted (step 368). The red object is then passed on to the recipient client subsystem.

Identification Authentication Authorization (IAA) Subsystem

IAAS 212 is responsible for identifying, authenticating and authorizing a user attempting to log in to UIA system 200. IAAS 212 interfaces with UDS 214, which is a storage and transmission device possessed by the user. In the implementation discussed, UDS 214 consists of a user token. IAAS 212 inputs and processes a user's token, PIN and biometrics via a trusted path and trusted processor that is independent of the untrusted operating system of a user's workstation.

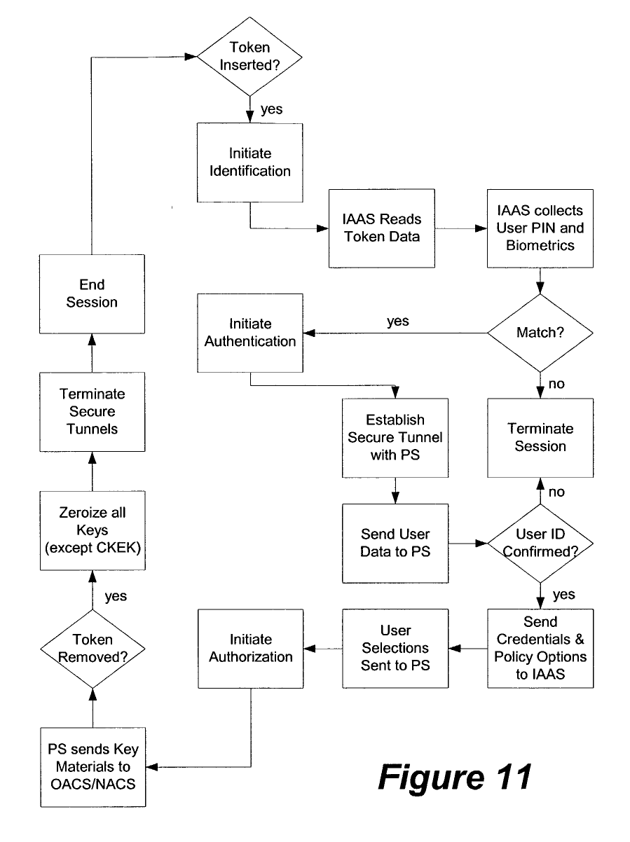

A method for identification, authentication and authorization according to the present invention is illustrated in FIG. 11. IAAS 212 includes a biometric device used to collect fingerprints or other biometric information from a user, and a display and keypad for user interaction. IAAS 212 continually monitors UDS 214 for insertion of a user token. When a token is detected, IAAS 212 initiates the identification portion of the log in process by collecting the user PIN (as entered by the user) and a user fingerprint provided to the IAAS biometric device. Identification proceeds by comparing this information with information contained on the user token. In one implementation, a token contains a user ID hash, a user PIN hash, two fingerprint templates and the token data size. IAAS 212 checks the identity of a user by (1) hashing the PIN entered by the user and checking it against the PIN hash contained on the token; and (2) matching the user fingerprint with the fingerprint templates contained on the token.

IAAS 212 counts the number of consecutive failures on these checks, and locks out further log on attempts after a predetermined number is exceeded. In one implementation, a user is locked out from further log on attempts after four unsuccessful attempts. The unsuccessful log on attempt is also reported to PS 222 via a secure tunnel established by NACS 260.

If both identification checks are passed, identification is successful and IAAS 212 proceeds with authentication. In one implementation, authentication proceeds by hashing the user token data, and sending the user PIN hash, token data size and token data hash to PS 222. PS 222 compares this with its stored data and returns an authentication response to IAAS 212 (via a secure tunnel established by the NACS). If the user is authenticated, PS 222 sends policy options (if any) to IAAS 212, which displays the received options for selection by the user. If the user is not authenticated, IAAS 212 informs the user and the log in process is terminated.

When IAAS 212 detects removal of the user token from UDS 214, user logout is initiated to terminate the user session. All key materials in the OACS and NACS are zeroized (except for the CKEK), and all secure tunnels are terminated.

Client Services

The client services component 280 comprises client subsystem (CS) 282 and trusted client subsystem (TCS) 284. CS 282, whose principle component is a user workstation, is the interface to the common user's computing environment. Preferably, the client subsystem software runs in a common operating environment, such as Microsoft Windows XP. CS 282 accepts data from a user and formats and presents the data to the cryptographic subystems (NACS 252 and OACS 260).

Preferably, a common format is used for all data objects. In one implementation, the format comprises three distinct sections: plain text information (metadata) that supports searching and sorting of the encrypted objects; message digests or hashes to preserve the integrity of the object and metadata during transmission; and the original data (i.e., the file). The searchable metadata fields may include the name of the encrypted object (before encryption); the size of the object (exclusive of metadata and before encryption); the title; the author; the subject; publication data; classification level; keywords for cataloging of the object; and the file type.

TCS 284 performs the same functions as CS 282, but may be provided for special functions such as regrading and publishing. TCS 284 operates in an evaluated environment to guaranteee process separation.

Network Services

Network services component 290 comprises network storage subystem (NSS) 292, network translation subsystem (NTS) 296 and infrastructure support subsystem (ISS) 294. NSS 292 is simply a central storage media for DAR-encrypted objects. It may include a document management system and a special search engine for searching the metadata contents of encrypted objects residing on the subsystem. NSS 292 may also provide attribute-based access control filtering to avoid advertisement of encrypted objects that a user cannot decrypt. In order to facilitate this function, user credential information is provided to NSS 292. NSS 292 itself provides no cryptographic functions, although of course it is fronted by an NACS to provide DIT encryption for objects in transit to/from NSS 292.

The encrypted objects stored on NSS 292 may be encrypted as different keys, as described, and even by different algorithms. Hence, NSS 292 supports storage of objects that are encrypted at different security levels on a common server. The encrypted objects are downloadable only by users possessing the credentials needed to decrypt the desired objects.

NTS 296 facilitates data retrieval from external networks and media sources. Any external data retrieved by NTS 296 is both DAR- and DIT-encrypted before entering the UIA network. ISS 294 facilitates network operations that require red (unencrypted) processing, such as domain controllers and e-mail servers. ISS 294 supports intra-system plaintext email transmission with possible encrypted attachments.

Other embodiments and implementations of the invention will be or will become apparent to one with skill in the art. All such additional embodiments and implementations are intended to be included within this description, to be within the scope of the invention and to be protected by the accompanying claims.

1. A system for protection and secure exchange of data objects over a computer network comprising:
an object access control subsystem that implements a first cryptographic function based on the content of the objects and the credentials of an originating user, the first cryptographic function granting access to the objects only to recipient users possessing appropriate credentials; and
a network access control subsystem that implements a second cryptographic function based on attributes of the network, the second cryptographic function ensuring secure and confidential transit of the data objects over the network.

2. A system as claimed in claim 1, and further comprising a policy subsystem that manages and distributes cryptographic keys to implement the first and second cryptographic functions based on the credentials of the users.

3. A system as claimed in claim 2, and further comprising an identification, authentication and authorization subsystem governing access to the system by all users.

4. A system as claimed in claim 3, wherein the identification, authentication and authorization subsystem inputs and processes a user's token, PIN and biometrics via a trusted path and trusted processor that is independent of an untrusted operating system of a user's workstation.

5. A system as claimed in claim 1, wherein the first cryptographic function comprises use of a symmetric object encryption key to encrypt/decrypt the data object and use of an asymmetric key to encrypt/decrypt a variable required to create the symmetric object encryption key.

6. A system as claimed in claim 1, wherein the second cryptographic function is implemented by a symmetric key created by secure and authenticated exchange of keying material between the originating and recipient user.

7. A method for secure exchange of data objects over a computer network comprising:
identification, authentication and authorization of an originating user;
determination of the originating user's credentials;
assignment of object and network cryptographic keys and materials to the originating user based on the originating user's credentials;
performing a first level of encryption on a data object using the object keys and materials assigned to the originating user;
performing a second level of encryption on the data object using the network keys and materials assigned to the originating user;
sending the data object over the computer network to a recipient user;
if the recipient user has appropriate network keys, performing a first level of decryption on the data object;
if the recipient user has appropriate object keys and materials, performing a second level of decryption on the data object;
access to the decrypted object by the recipient user.

8. A method for encrypting a data object, comprising the following steps:
generating a symmetric key from a plurality of key elements, wherein the plurality of key elements comprise a first key element that is not in possession of an intended recipient;
encrypting the data object using the symmetric key;
encrypting the first key element using an asymmetric key; and
sending the encrypted data object and encrypted first key element to the intended recipient.

9. A method as claimed in claim 8, wherein the plurality of key elements comprise a prime modulus “p”, a primitive element “g” and a random number “R”.

10. A method as claimed in claim 9, wherein the symmetric key is generated as g^{R} mod p.

11. A method as claimed in claim 10, wherein the first element that is not in the possession of the intended recipient is the random number R.

12. A method as claimed in claim 11, wherein the encrypted first key element is placed in a plaintext header attached to the encrypted data object.

13. A method as claimed in claim 12, wherein R is separately encrypted with a plurality of asymmetric keys, and all encrypted values of R are placed in the header to make the object accessible to a greater number of recipients.

14. A method as claimed in claim 12, wherein R is sequentially-encrypted using a plurality of asymmetric keys, and the sequentially-encrypted value of R is placed in the header to make the object accessible to a lesser number of recipients.

15. A method for decrypting a data object, comprising the following steps:
receiving an encrypted data object and encrypted key element from a sender;
decrypting the key element using an asymmetric key;
generating a symmetric key using the decrypted key element and additional key elements possessed in common with the sender; and
decrypting the data object with the symmetric key.

16. A system for protection of data objects comprising:
means for a sender to generate a symmetric key from a first key element not possessed by a recipient and an additional key element possessed by the recipient;
means for the sender to encrypt a data object with the symmetric key;
means for the sender to encrypt the first key element with an encrypting half of an asymmetric key pair;
means for the recipient to decrypt the first key element with a decrypting half of an asymmetric key pair;
means for the recipient to generate the symmetric key using the decrypted first key element and the additional key element; and
means for the recipient to decrypt the data object using the symmetric key.

16. A system for storage of encrypted objects, wherein the encrypted objects may be encrypted via different algorithms and different keys so as to support storage of objects that are encrypted at different security levels on a common server.

17. A system for storage of encrypted objects that are encrypted at different security levels, wherein the encrypted objects are downloadable only by those users possessing the credentials needed to decrypt the downloaded objects.
